(19) United States
(12) Patent Application Publication
(10) Pub. No.: US 2006/0102565 A1
(43) Pub. Date: May 18, 2006

(54) System and method for dewatering sludge, slurry or sediment

(76) Inventor: Paul W. Alford, Loranger, LA (US)

Correspondence Address: WONG, CABELLO, LUTSCH, RUTHERFORD & BRUCCULERI,;P.C., 20333 SH 249, SUITE 600, HOUSTON, TX, 77070, US

(21) Appl. No.: 10/987,383

(22) Filed: Nov. 12, 2004

(51) Int. Cl. C02F 11/12

(52) U.S. Cl. 210/770; 210/416.1; 210/435

(57) ABSTRACT

A system and method for dewatering sludge, slurry, sediment, or like material includes a dewatering device having a permeable, collapsible enclosure positioned within an impermeable, collapsible enclosure. The enclosures can be substantially tubular and formed from sheets with sealed edges. A fill pump connectable to an inlet on the device pumps the material into the permeable enclosure and inflates the enclosures. Liquid from the material is allowed to flow into an at least partial space between the enclosures and can be drained from an outlet on the device communicating with the space. Preferably, a separation layer in the form of a mesh is at least partially inserted in the space between the enclosures. A vacuum pump connectable to the outlet collapses the impermeable enclosure about the permeable enclosure and draws liquid from the space between the enclosures.

### FIELD OF THE INVENTION

The subject matter of the present disclosure generally relates to a system and method for removing liquid from a material, such as sludge, slurry, sediment, or like material.

### BACKGROUND OF THE INVENTION

Materials having a mixture of solid and liquid occur naturally in various environments or are produced as by-products in many industries. Typical examples of such materials include sludges, slurries, sediments, suspensions, emulsions, or the like. These materials can be heavy so that it is advantageous to remove as much liquid from the material before it is transported. In addition, the solid component of the mixture may have value, or a landfill may not accept the material unless it has a specific solid content. Therefore, it may be desirable in some applications to remove as much liquid from the material as possible so that the solid component can be more easily or more economically reused, sold in a secondary market, or disposed in a landfill.

Various techniques are known in the art for removing the liquid component from materials (e.g., “de-watering” sludge). The various techniques of the prior art use drying beds, geo-textile tubes, centrifuges, rotary drum vacuum filters, horizontal vacuum filters, horizontal belt presses, and filter presses. For example, some techniques in the prior art are disclosed in U.S. Patent Applications 2004/0011749 and 2002/0113014; in U.S. Pat. Nos. 4,836,937, 4,983,282, 5,143,615, and 5,022,995; and in Foreign Patents EP0238895 and JP62-210018, all of which are incorporated herein by reference. Some of these prior art techniques use complex mechanical components to remove liquid from the material. Other less-mechanical prior art techniques may take a significant amount of time to remove liquid from the material and may allow liquids, odors, and other emissions to escape to surrounding areas.

In one prior art technique, geo-textile tubes are filled with the solid-liquid material to be dewatered. A commercial example of a geo-textile tube is the Geotube® by Ten Cate Nicolon of Commerce, Georgia. The geo-textile tubes are formed of a geo-textile fabric, such as woven polypropylene or polyester fabric, although the “tube” need not necessarily be tube shaped. To dewater the material, the geo-textile tubes are laid out at a site and then filled with the material through an inlet in the tube. Over time, small pores in the fabric confine solids of the material while allowing free water to drain from the fabric by hydraulic pressure, gravity, and/or capillary action. Unfortunately, the dewatering process can be rather lengthy, taking months in some instances. In addition, the geo-textile tubes may need to be segregated or contained within a retention area to prevent run-off of the liquid. For example, the geo-textile tubes may be placed in a lined and bermed dewatering basin. As a dewatering project progresses, more and more geo-textile tubes must be laid out at the site, requiring a significant amount of space. Furthermore, noise, odors, or other emissions may be a hazard or a nuisance to surrounding areas during dewatering or loading operations.

Advancements in dewatering techniques that can shorten the duration of dewatering operations and subsequently lower equipment and labor costs are very desirable. Ideally, a dewatering operation is capable of removing a significant amount of liquid from the material at a minimum cost and in the shortest amount of time. The resultant solid would preferably have the physical characteristics and the moisture desired for transporting and disposing. Because dewatering operations may produce significant amounts of material, it is desirable to have an inexpensive, mechanically non-complex, environmentally sound, and faster technique for dewatering large amounts of material. The subject matter of the present disclosure is directed to overcoming, or at least reducing the effects of, one or more of the problems set forth above.

### SUMMARY OF THE DISCLOSURE

Systems and methods for dewatering sludge, slurry, sediment, or like material include a dewatering device having a permeable, collapsible enclosure positioned within an impermeable, collapsible enclosure. The enclosures can be substantially tubular and formed from sheets of material having sealed edges. A fill pump connectable to an inlet on the device pumps the material into the internal permeable enclosure. Liquid from the material pumped into the internal permeable enclosure is allowed to flow into an at least partial space between the permeable and impermeable enclosures and can be drained from an outlet on the device communicating with the space. Preferably, a separation layer in the form of a mesh or net is wrapped around the inner permeable enclosure to maintain the space between the enclosures. As the device is filled with material, the inner permeable enclosure increases in size and filters water (filtrate) from the material due to pressure buildup within the device. The filtrate is then conveyed along the length of the device to an outlet where the filtrate can be initially drained.

Preferably, a vacuum pump connects to the outlet of the device and draws a vacuum pressure of up to 30 inches of mercury. As the vacuum pump operates, a vacuum is created in the separation layer to increase the speed of filtration. Ultimately, as the vacuum is drawn, the impermeable enclosure collapses about the permeable enclosure. Liquid filtrate is drawn from the impermeable enclosure to the space between the enclosures and is drawn through and along the separation layer to the vacuumed outlet of the device. The separation layer preferably substantially surrounds the inner permeable enclosure so that the vacuum is maintained almost completely around the entire permeable enclosure. In this way, the impermeable enclosure can be prevented from sealing against the inner permeable enclosure.

The entire dewatering device can be sized to meet the load capabilities of trucks, trailers, railcars, or barges, and can be transported and dumped after removing liquid from the material. Furthermore, a vacuum unit may be stationed at the disposal or reuse facility to quickly and efficiently recover any additional liquids that may have settled by gravity during transport of the device. Alternatively, at least a portion of the device can be reusable. In one example, the impermeable enclosure can be opened, and the permeable enclosure with the dewatered material inside can be removed for transportation and disposal. In this embodiment, additional components, such as nylon straps, can be used on the permeable enclosure to assist in the removal of the permeable enclosure from the impermeable enclosure. The dewatering pad on which the device is positioned at a site can also be sloped to facilitate the removal of the permeable enclosure. In the reusable embodiment of the device, a clamp device can then be used to seal the open end of the impermeable enclosure after a new permeable enclosure has been positioned inside.

The foregoing summary is not intended to summarize each potential embodiment or every aspect of the present disclosure.

### BRIEF DESCRIPTION OF THE DRAWINGS

The foregoing summary, preferred embodiments, and other aspects of subject matter of the present disclosure will be best understood with reference to a detailed description of specific embodiments, which follows, when read in conjunction with the accompanying drawings, in which:

FIG. 1 illustrates a system for removing liquid from material according to certain teachings of the present disclosure including a dewatering device.

FIG. 2 illustrates a cross-sectional view of an embodiment of the device of FIG. 1.

FIG. 3A illustrates a perspective view of a permeable enclosure, an impermeable enclosure, and an inlet of the disclosed device.

FIG. 3B illustrates a perspective view of a permeable enclosure and a separation layer of the disclosed device.

FIG. 4 illustrates an embodiment of a separation layer of the disclosed device.

FIG. 5 illustrates another embodiment of a permeable enclosure of the disclosed device.

FIG. 6A-6C illustrate a reusable embodiment of the disclosed device in a number of stages.

FIG. 7 illustrates an embodiment of a fill port for the disclosed device.

FIG. 8 illustrates an embodiment of a clamping device for resealing an open end of an impermeable enclosure of the disclosed device.

FIGS. 9-11 illustrate embodiments for orienting and/or transporting the disclosed device.

While the disclosed system, devices, and methods are susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION

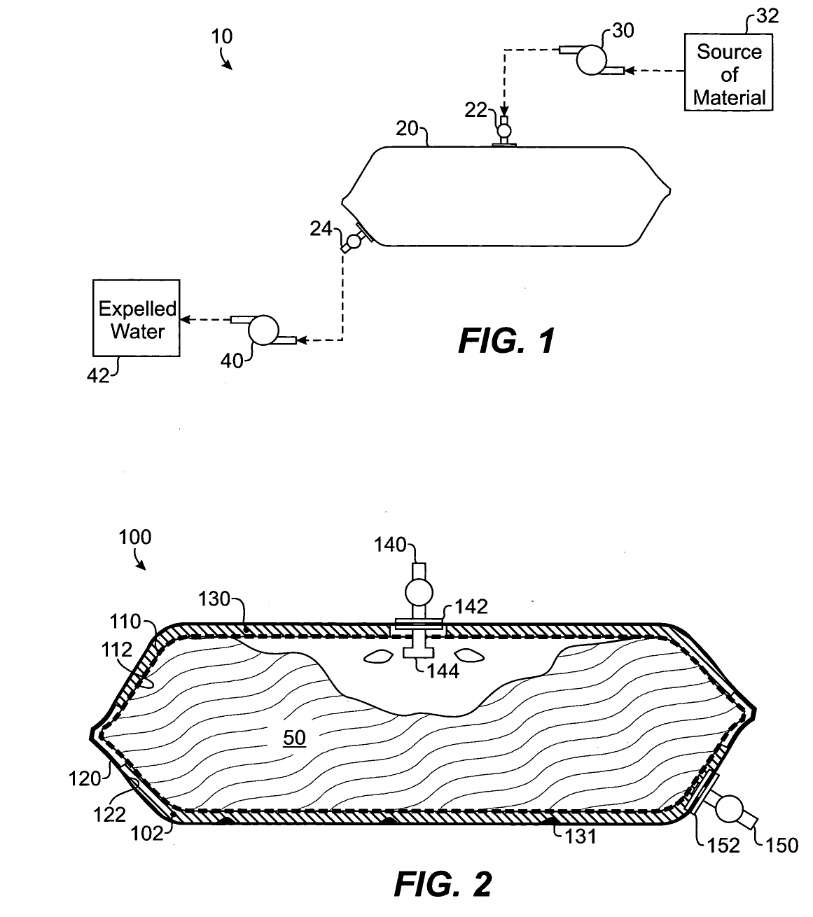

Referring to FIG. 1, a system 10 for removing liquid from a material having a liquid-solid mixture is illustrated. In the present disclosure, the system 10 is used for dewatering (e.g., removing water from) sludge, slurry, sediment, or like material by way of example only. One skilled in the art will appreciate that the disclosed system 10 can be used to remove liquids from various materials. In one example, the system 10 can be used in projects to dewater sludge from a riverbed. In another example, the system 10 can be used in projects involving upstream grain size separation, such as shaker screen or hydro-cyclone operations. Use of the disclosed system 10 for such projects may allow clean sand, gravel, or rock to be recovered for other uses prior to dewatering any remaining fine grain sands and more commonly contaminated organic sediments and clay fines of the material.

Prior to disclosing details of the dewatering device, general system considerations are first discussed. The system 10 includes a dewatering device 20, a fill pump 30, and a vacuum pump 40. The fill pump 30 pumps material from a source 32 to the dewatering device 20, which can constitute sludge, slurry, sediment, or the like. The fill pump 30 pumps the material into the dewatering device 20 via an inlet or fill port 22. The fill pump 30 is selected in accordance with the size of the device 20 and the amount and type of material to be pumped. A suitable fill pump 30 for a typical implementation is a six to ten-inch centrifugal feed pump or a hydraulic submersible pump.

Because the material contains water or other liquid, the dewatering device 20 removes the water to make transporting the material easier or to make the solid component more suitable for disposal, as alluded to earlier. Therefore, the dewatering device 20 filled with the material is used to substantially remove liquid from the material. To facilitate the dewatering process, it may be desirable to pre-treat the material with polymer or other pretreatment techniques known in the art that are designed to enhance liquid/solid separation. For example, a chemical treatment, including, but not limited to, cationic or ionic polymers, coagulants, or PH altering amendments, may be added to the material via direct injection or batch mixing prior to filling the device 20.

In a preferred embodiment, a valve on the fill port 22 is closed after filling the dewatering device 20, and vacuum pump 40 is connected to the vacuum port 24 to introduce a vacuum to the device to in effect “suck” the liquids from the materials within the device 20. (It should be understood that “liquids” as referred to in this disclosure need not necessarily be completely free of any and all sediment). The vacuum pump 40 is sized in accordance with the size of the device or devices 20 with which it is used. The pressure of the vacuum introduced on the device 20 can be approximately twenty-seven inches of mercury or greater. A suitable vacuum pump 40 for a typical implementation is a liquid ring vacuum pump, and one vacuum pump 40 may be capable of drawing a vacuum and liquid from a plurality of devices 20 at one time. Depending on the particular size of the device 20, more than one vacuum port 24 may be provided on the device 20 so that more than one vacuum pump 40 can be used to draw vacuum on the device 20, or so that a single vacuum pump 40 can be used to draw the vacuum from more than location on the device 20.

When operated, the vacuum pump 40 draws air and excess water from the device 20 and expels the water to a suitable holding area, tank, or the like (42). Because the device 20 is collapsible, as will be explained further below, the device 20 collapses about the material within the device 20 as the vacuum is applied. The constant reduction in size coupled with the vacuum causes the material to be consolidated and made denser within the device 20. In one embodiment, the entire device 20 may be expendable and only used once for dewatering material. Alternatively, the entire device 20 or at least portions thereof can be reusable to dewater additional material, as explained further below.

The disclosed system 10 may offer several advantages over existing techniques for removing liquid from material. For example, the disclosed system 10 can produce dryer and/or denser dewatered material in less time compared to other techniques known in the art. For example, filling the device 20 may take three to five hours, and dewatering with the device 20 and vacuum pump 40 may take as little as three to five hours to complete, essentially allowing materials to be loaded and dewatered in a day's shift. The device 20 is believed to be capable of producing dewatered material having a concentration up to or in excess of seventy percent solids on a dry-weight basis depending on the physical characteristics of the material.

In addition, the system 10 can reduce the cost of dewatering material when compared to prior art techniques. For example, it is currently expected that the system 10 will create higher solid content in the dewatered material, which results in lower tonnage for transportation. Costs may also be reduced due to faster dewatering and less capital-intensive equipment. Furthermore, the system 10 can greatly reduce the space required for a dewatering project, as more bags can be dewatered during a given period of time, reducing storage requirements. Moreover, odors, run-off, and other emissions from physical exposure can be reduced with the system 10.

Finally, the system 10 lends itself to traditional methods of chemical pre-treatment and may require lower chemical dosages currently associated with use of the geo-textile tubes of the prior art. Similarly, the system 10 may maximize recovery of many volatile and semi-volatile organic contaminants within the system 10, reducing the need for high carbon filtrate polishing costs associated with mechanical dewatering, because the sand or other inorganic fine particulates in the material being dewatered can acts as a filtration aide within the system 10.

With the foregoing understood, an embodiment of the dewatering device 20, shown as dewatering device 100 in FIG. 2, is illustrated in cross-section in further detail. The device 100 includes an internal enclosure 110, an external enclosure 120, an intervening separation layer 130, an inlet or fill port 140, and an outlet or vacuum port 150. The internal enclosure 110 is permeable, collapsible, and defines an interior 112 for containing the material 50 to be dewatered. The external enclosure 120 is impermeable, collapsible, and defines an interior 122 in which the permeable enclosure 10 is ensealed. Because the external enclosure 120 is impermeable and sealable about the permeable enclosure 110, the external enclosure 120 encapsulates the permeable enclosure 110 and the material 50 within the device 100. Thus, the impermeable external enclosure 120 reduces the potential for airborne emissions or physical contact with recovered material 50, making the dewatering process cleaner, neater, and less hazardous.

The separation layer 130 is at least partially positioned within a space 102 between the enclosures 110 and 120. When the device 100 is constructed and filled with material 50, the separation layer 130 maintains at least some of the separation or space 102 between the enclosures 10 and 120 in which a vacuum can be drawn. In addition, the separation layer 130 provides a void for conveyance of liquid from the permeable enclosure 110 to the outlet 150. Preferably, at least a portion of the separation layer 130 is attached to the impermeable enclosure 120. For example, the separation layer 130, which is preferably composed of plastic material, can be spot extrusion welded at a plurality of points 131 along the bottom of layer 130 to attach it to the impermeable enclosure 120, which is also preferably composed of a plastic material.

The fill port 140 communicates the outside of the device 100 to the interior 112 of the permeable enclosure 110 and is intended to connect to a fill pump 30 (FIG. 1) for filing the device 100 with the material 50. The fill port 140 is preferably positioned substantially near a central location of the device 100 and preferably on top of the device 100, as shown in FIG. 2. In addition, the fill port 140 preferably has a T-shaped nozzle or end 144 for dividing or spreading the pumped material 50 into the permeable enclosure 110. The vacuum port 150 communicates with the space 102 between the enclosures 110 and 120, and is intended to connect to a vacuum pump 40 (FIG. 1), which extracts air and water from the device 100. Couplings 142 and 152, which can include flanges, seals, and the like, attach the ports 140 and 150 to the external enclosure 120. The ports 140 and 150 may include valves, caps, or the like to seal off the ports. Depending on the size of the device 100, more than one fill port 140 and/or vacuum port 150 may be provided to fill and/or drain the device 100.

In use, the material 50 is pumped into the device 100 through the fill port 140 as just noted. The material 50 may or may not have been chemically treated using the chemistries discussed above to enhance liquid/solid separation. As it is pumped, the material 50 fills the interior 112 of the permeable enclosure 110. The T-shaped end 144 of the fill port 140 preferably separates the flow of the material 50 toward opposite ends of the device 100 so as to prevent clogging that could result if the material 50 were simply allowed to fill at the center or at one end of the device 100. It is believed that central but distributed filling may help to evenly distribute sediments of potentially varying density within the device 100. In this way, evenly-distributed smaller granular particles such as sand can enhance liquid solid separation, can increase overall solid content, and can act as a filter to capture some of the potential contaminants that may be contained within water, sediment, or clay fines.

As the device 100 is filled with material 50, the collapsible enclosures 110 and 120 expand or inflate. With the material 50 in the device 100, the permeable enclosure 110 releases filtered water (often referred to as filtrate) into the void or space 102 between the enclosures 110 and 120. The release of the filtrate can initially occur under the hydraulic pump pressure while the material 50 is being pumped into the inlet 140 of the device 100 with the fill pump 30 (FIG. 1). In addition, the release of filtrate can occur with the assistance of gravity and capillary action while the device 100 rests at a site. Solids of the material 50 are continually consolidated within the permeable enclosure 110.

The filtrate may be freely drained from the vacuum port 150 of the device 100. More preferably however, a vacuum is introduced at the vacuum port 150 before or after the device 100 is sealed (e.g., at a valve on fill port 140). When an exemplary vacuum pressure of approximately twenty-seven inches of mercury or greater is applied to the vacuum port 150, a vacuum is maintained within the device 100. This causes the impermeable enclosure 120 to collapse about the permeable enclosure 110 thus squeezing the material 50 within the device 100. The separation layer 130, which at least partially surrounds the permeable enclosure 110, maintains the void or space 102 between the enclosures 110 and 120. Thus, as the vacuum is drawn, the separation layer 130 does not allow portions of the impermeable enclosure 120 to seal against the permeable enclosure 110, but instead allows the filtrate to flow from the permeable enclosure 110 to the vacuum port 150.

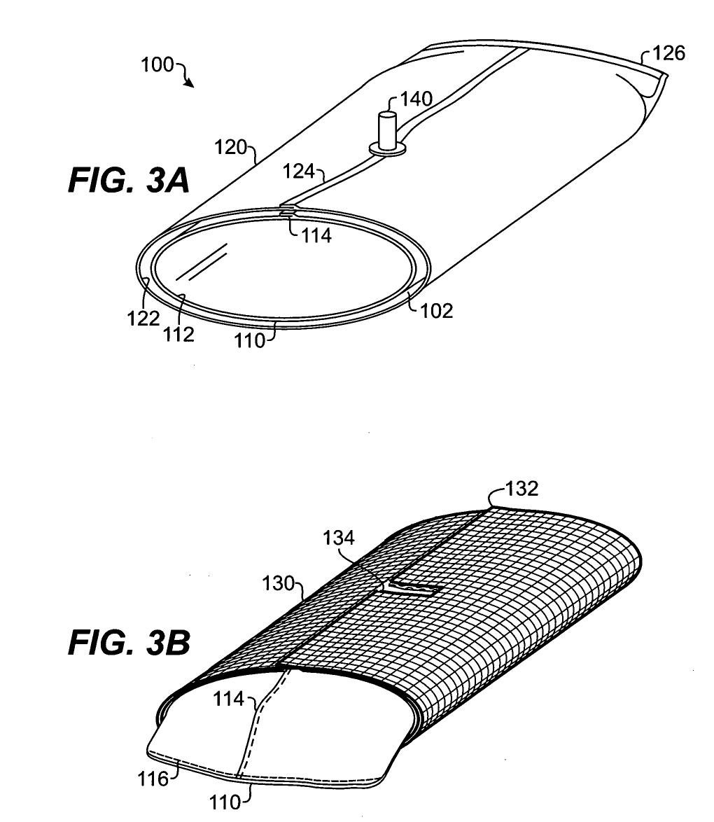

FIGS. 3A and 3B shows components of the device 100 in further detail. In FIG. 3A, the permeable enclosure 110 and impermeable enclosure 120 are illustrated in a perspective view with one end of the device 100 opened. In FIG. 3B, the permeable enclosure 110 and the separation layer 130 of the device 100 are illustrated in a perspective view.

The permeable enclosure 110 is preferably formed from one or more sheets of permeable material and is substantially tubular, although the enclosure 110 can have other shapes. Preferably, the permeable material for the enclosure 110 is a woven polypropylene or polyester fabric, which is also known as a geo-textile or woven filtration fabric. The thickness and permeability of the material can be selected based on the material to be dewatered, for example. The seams or edges 114 and 116 of the permeable enclosure 110 are preferably sewn with nylon stitching, using techniques known in the art. For example, “J” seams with double lock stitches can be used for the edges 114 and 116.

As best shown in FIG. 3A, the impermeable enclosure 120 is also preferably made from one or more sheets of impermeable material and is substantially tubular, although the enclosure 120 too can also have other shapes. In one embodiment, the impermeable material of the enclosure 120 is high-density polyethylene (HDPE) of about 30 to 60-mils thick. The edges or seams 124 and 126 of the impermeable enclosure 120 are preferably sealed by extrusion welding, again a well-known technique. In this embodiment, the components of the fill port 140 and vacuum port (not shown) can also be sealed by extrusion welding or by compression fittings (e.g., flanges and gasket). In another embodiment, the impermeable material of the enclosure 120 is a polyvinyl chloride geo-membrane sheet of about 20 to 40-mils thick. The seams 124 and 126 of the impermeable enclosure 120, when composed of the polyvinyl chloride geo-membrane, are preferably sealed by hot jet welding techniques, again a well-known technique. The components of the fill port 140 and vacuum port 150 in this case can be sealed by gluing or injection fitting. The materials and the method of sealing or welding are selected to withstand the intended vacuum levels.

The impermeable enclosure 120 is sized larger than the permeable enclosure 110 so that the space or separation 102 exists between them. As noted earlier, the space 102 can provide a sufficient void so that filtered liquid can drain, and to withstand the vacuum in embodiments in which vacuum pressures are used. If the impermeable enclosure 120 were oversized too much, it is believed that the enclosure 120 might buckle and rupture during high levels of vacuum. Therefore, the impermeable enclosure 120 is preferably sized approximately ten to fifteen percent larger than the permeable enclosure 110 in its circumference.

As best shown in FIG. 3B, the separation layer 130 is preferably a mesh, net, or lattice structure composed of about 200 to 300-mil geo-synthetic (polyethylene) material. Unlike the textile from which the permeable enclosure 110 is made, the separation layer 130, while also generally deformable, is preferably a much thicker and sturdier mesh than the permeable enclosure 100, perhaps ¼ to 1 inch in thickness, and having openings therein on the order of ½ to 2 inches in effective diameter. Preferably, the mesh of the separation layer 130 allows flow of liquid through holes in the mesh so that filtrate from the permeable enclosure 110 can be drawn to the vacuum port of the impermeable enclosure. One suitable type of mesh is similar to that typically used beneath large municipal solid waste landfills to collect hazardous landfill leachate between impermeable HDPE liners with thousands of tons of garbage above.

In a preferred embodiment, the separation layer 130 is a continuous sheet of the mesh material substantially formed into a cylinder about the permeable enclosure 110 and made to fit substantially the entire length of the permeable enclosure 110. Having the separation layer 130 formed from one sheet is posited to enhance the strength of the permeable enclosure 110 during maximum fill pressures. In this preferred embodiment, edges 132 of layer 130 are unattached and are allowed to overlap one another so that the layer 130 can expand and contract in overall diameter as the permeable enclosure 110 is filled and emptied. Cutaways 134 are formed in the edges 132 for accommodating structures of the fill port (not shown).

Although the preferred embodiment of the separation layer 130 in FIG. 3B is one sheet of mesh formed substantially into a cylinder, alternative embodiments can include a plurality of separate sheets of mesh, net, or lattice positioned about the permeable enclosure 110. In addition, other structures can be used as separators to maintain at least some of the separation or space 102 between the enclosures 110 and 120 shown in FIG. 3A and to allow liquid to drain from the permeable enclosure 110 to the vacuum port (not shown). In one alternative embodiment, the one or more separators or separation layer 130 for the device 100 can include a plurality of structures (e.g., ribs or bumps formed on the inside 122 of the impermeable enclosure 120, pipes, rope, chain, balls, strips, boards, slats, etc.) positioned into the space 102 between the enclosures 110 and 120. In short, the various separators used to provide a space 102 between the enclosures 110 and 120 can be formed as parts of those enclosures, or as a distinctly separate layer. Regardless, such separator mechanisms form a separate “separation layer,” and it should be understood that the “separation layer” 130 can include structure either distinct from the enclosures 110, 120, or which are merely extensions from those enclosures. Moreover, a “separation layer” need not constitute a layer (i.e., mesh) in the traditional sense of the terms, but can also include various bumps or spacers functionally creating a layer within the device, even if not integrally formed as a unitary layer.

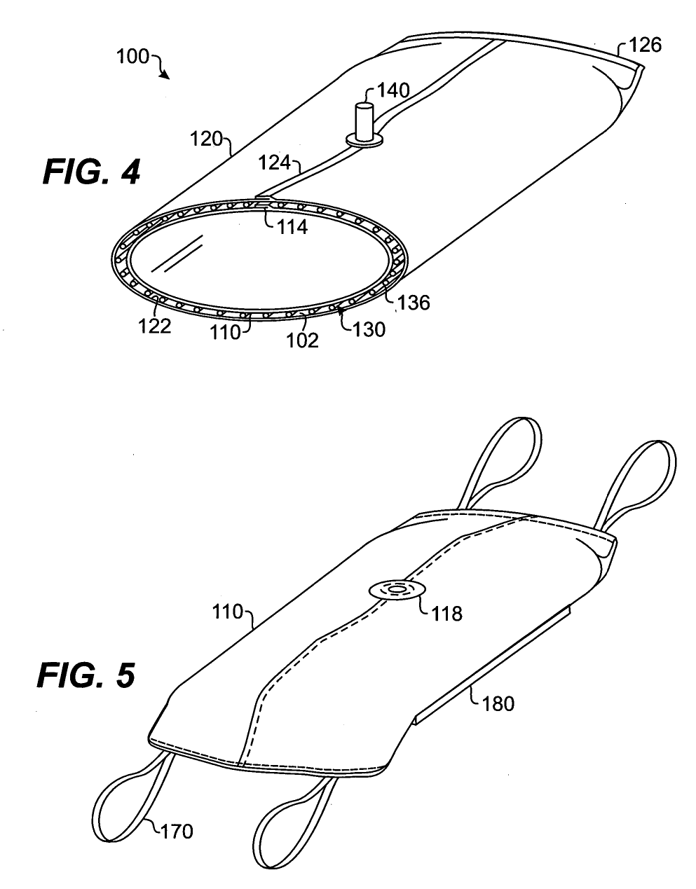

Referring to FIG. 4, an alternative embodiment of the separation layer 130 includes a plurality of pipes 136 positioned longitudinally into the space 102 between the enclosures 110 and 120. The pipes 136 can be perforated with a plurality of slots or holes (not shown) along their lengths to allow vacuum suction and fluid drainage therethrough. The pipes 136 can be freely inserted into the space 102, or can be attached to the inner surface 122 of the impermeable enclosure 120, or can be inserted into the space 102 but interconnected to one another by a rope, fabric, or other flexible structure (not shown).

Referring to FIG. 5, further details of the permeable enclosure 110 are illustrated. An opening 118 is shown in the enclosure 110 for entry of the fill port (not shown) into the interior of the enclosure 110. Preferably, reinforcement is sewn about this opening 118. In the present embodiment, the enclosure 110 includes a plurality of straps or loops 170 attached to the ends of the enclosure 170. The straps 170 are preferably made of nylon and are sewn horizontally along the full length of the permeable enclosure 110. As described in more detail below, the straps 170 can allow the internal enclosure 110 to be moved.

In the present embodiment, the permeable enclosure 110 can also include a base layer 180 sewn to the bottom of the removable permeable enclosure 110. The base layer 180 can be made of the same mesh, net, or lattice material of the separation layer 130 discussed above with reference to FIG. 3B. In one example, the base layer 180 can be approximately 44 feet long by 15 feet wide and sewn with nylon stitching directly to the bottom of the permeable enclosure 110 and to the nylon straps 170 on either side. The base layer 180 can enhance the flow of liquid from the permeable enclosure 110, and in conjunction with the straps 170 can allow the permeable enclosure 110 to be moved.

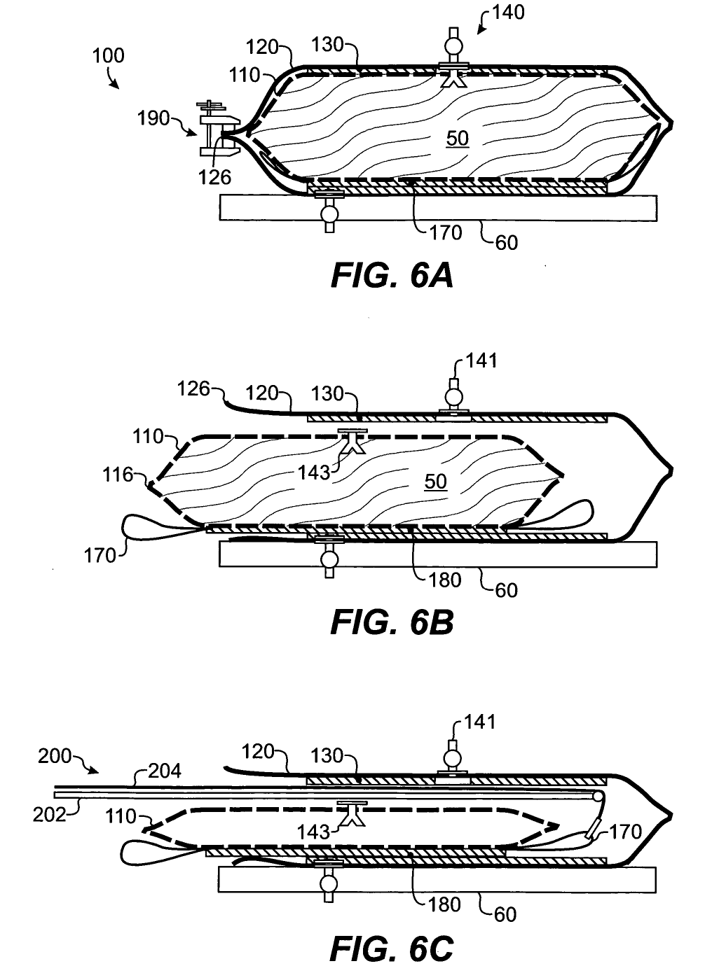

Referring to FIGS. 6A-6C, a reusable embodiment of the device 100 is illustrated in a number of stages of use. In such embodiments, the permeable enclosure 110 is retrievable from the impermeable enclosure 120 after a dewatering operation to allow a new (i.e., empty) permeable enclosure 110 to be used. In this reusable embodiment, the impermeable enclosure 120 has a re-sealable end 126 that is sealed by a clamping device 190. In one embodiment, the clamping device 190 includes one or more C-clamps and upper and lower bars clamping the open end 126 of the enclosure 120 along the width of the device 100. In an alternative embodiment, the re-sealable end 126 of the enclosure 120 can be sealed by extrusion welding, and later cut open to remove the permeable enclosure 110. The cut end 126 can then be resealed later by a clamping device 190 or by extrusion welding to seal the impermeable enclosure 120 about a new permeable enclosure 110.

In FIG. 6B, the material 50 in the device 100 has been dewatered and consolidated, and the clamping device 190 has been removed to open the end 126 of the impermeable enclosure 120. An external portion 141 and an internal portion 143 of fill port 140 are detached from each other. Then, the straps 170 are used to pull the permeable enclosure 110 out of the impermeable enclosure 120. The base layer 180 attached to the bottom of the permeable enclosure 110 can facilitate the sliding of the enclosure 110 over the separation layer 130. Alternatively, the permeable enclosure 110 can be removed without the addition of nylon straps 170 or base layer 180 by opening the impermeable enclosure 120 and inclining the surface 60 supporting the device 100 to “slide” the enclosure 110 out of the device. Of course, the impermeable enclosure 120 must be firmly attached to the inclined surface 60 to allow the permeable enclosure 110 to slide out.

In one embodiment, the permeable enclosure 110 can be expendable, in which case it can be entirely removed from the impermeable enclosure 120 and disposed of along with the dewatered material 50 contained therein. Alternatively, the permeable enclosure 110 can itself be reusable. For example, stitching or clamps (not shown) sealing an end 116 of the permeable enclosure 110 can be removed to open the enclosure 110 and remove the material 50. After removing the material 50, the end 116 can be re-stitched or re-clamped so that the enclosure 110 can be reused. If the permeable enclosure 110 is to be reused, the re-stitching of the end 116 of the permeable enclosure 110 should be substantially straight to prevent opening when being re-filled. Ultimately, reuse of the permeable enclosure 110 may be limited by any lost strength or clogging of the geo-textile fabric used for the enclosure 110, and thus may only be re-useable a limited number of times.

After disposal, an empty permeable enclosure 110 can be inserted into the impermeable enclosure 120 as shown in FIG. 6C. For example, an insertion device 200 can be used with the loops 170 of the permeable enclosure 110 to position it within the impermeable enclosure 120. The insertion device 200 can include a pole 202 and a draw line 204 attached to the loops 170 to pull the internal enclosure 110 into the external enclosure 120. Alternatively, the insertion device 200 can simply include the pole 202 catching on the loops 170 to push the internal enclosure 110 into the external enclosure 120. Once inserted, the end 126 of the external enclosure 120 can be resealed using any of the techniques described above. In yet another alternative, sealable holes (not shown) can be formed in an end of the impermeable enclosure 120, and nylon rope (not shown) can be attached to the straps 170 to pull the permeable enclosure 110 into the impermeable enclosure 120. Once the permeable enclosure 110 is positioned in the impermeable enclosure 120, the sections 141 and 143 of the fill port can be attached together.

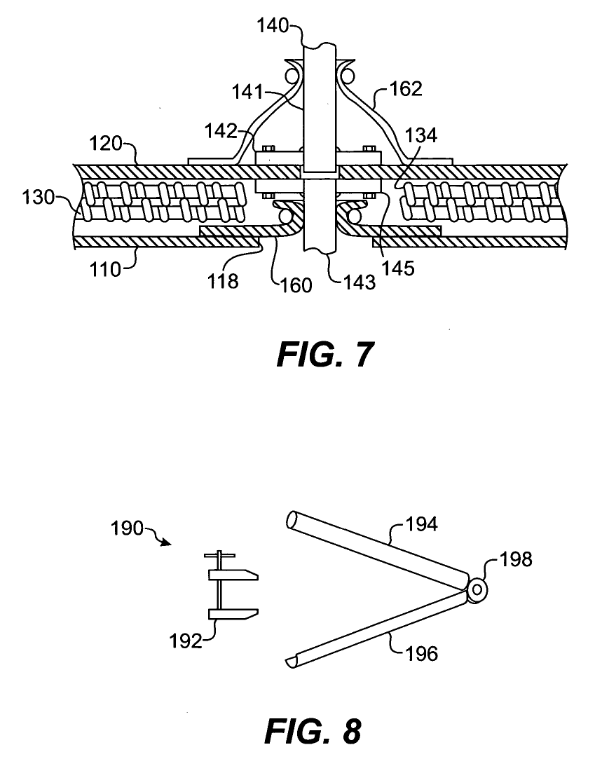

Referring to FIG. 7, an embodiment for the inlet or fill port 140 of the device is illustrated in cross-section. The fill port 140 includes an external pipe section 141 connected to a flange 142 and an internal pipe section 143 likewise connected to a flange 145. The external flange 142 positions on the outside of the impermeable enclosure 120 at an opening, while the internal flange 145 positions on the inside of the impermeable enclosure 120 at the opening. Ultimately, the flanges 142 and 145 can be bolted together using bolts passing through holes in the impermeable enclosure 120. The opening of the permeable enclosure 120 can be reinforced with additional layers of material (not shown) welded about the opening.

When the fill port 140 is assembled, the internal pipe section 143 fits through the opening 134 (see FIG. 3B) in the separation layer 130 and fits through the opening 118 (see FIG. 5) in the permeable enclosure 110 to convey material 50 into the enclosure 110. A first sock or port 160 made of geo-textile fabric is sewn about the opening 118 of the permeable enclosure 110 and is attached to the internal pipe section 143, for example, by banding, cinching, or by other suitable techniques. The first sock 160 may extend about 3 feet above the opening 118. Similarly, a second sock or port 162 made of HDPE is welded about the opening of the impermeable enclosure 120 and is banded, cinched, etc., to the external pipe section 141 of the fill port 140.

When the permeable enclosure 110 is to be removed from the impermeable enclosure 120, the second sock 162 can be unattached, and the flanges 142 and 145 unconnected. Hence, the internal pipe section 143 and flange 145 can be removed along with the permeable enclosure 110. Alternatively, the pipe section 143 and flange 145 can be removed from the permeable enclosure 110 and reused.

Referring to FIG. 8, an embodiment of a clamping device 190 is illustrated for resealing an open end 126 of the impermeable enclosure 120 (not shown). The clamping device 190 includes a first full pipe 194 and a second half pipe 196 connected together at one end by a hinge 198. The half pipe 196 may have a larger diameter than the full pipe 194. The pipes 194 and 196 are closed about the open end 126 of the impermeable enclosure 120, and one or more C-clamps 192 clamp along necessary intervals of the pipes 194 and 196 to seal the end of the impermeable enclosure.

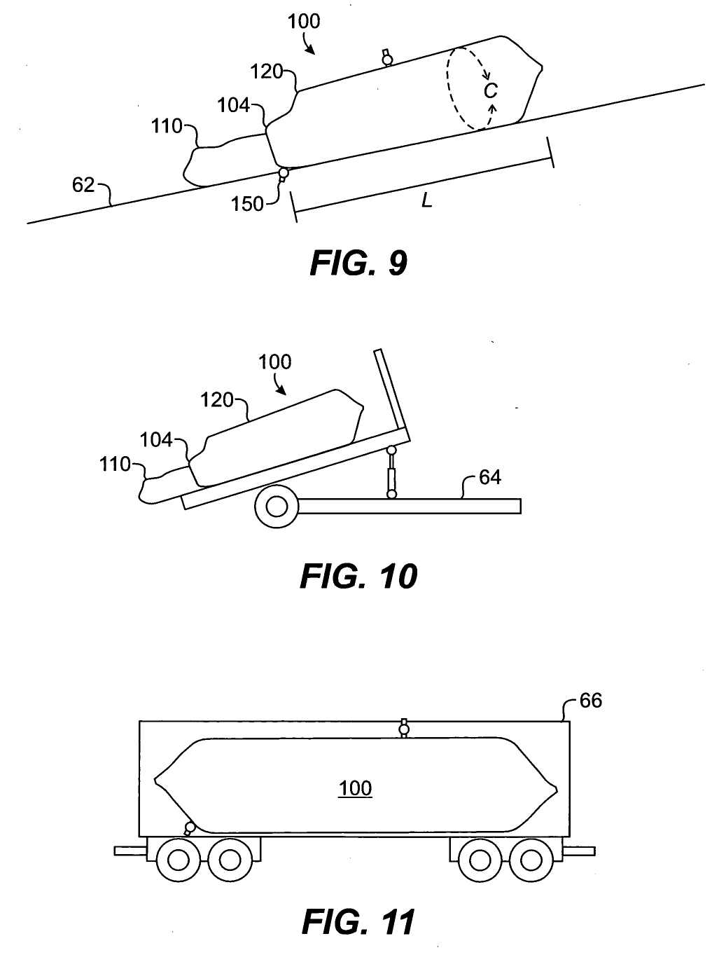

Referring to FIG. 9, an embodiment for orienting the device 100 is illustrated. The device 100 can be sized to the specific needs of each dewatering project, and a plurality of devices 100 can be used for a given project. In one embodiment, the device 100 can be approximately 44 feet long (L) and 30 feet in circumference C, i.e., about 15 feet wide when empty and laid flat. In another embodiment, the impermeable enclosure 120 of the device 100 can be approximately 52 feet long (L) and 22 feet in circumference (C), while the permeable enclosure 110 (not shown) can be approximately 51 feet long L and 21 feet in circumference C. A dewatering pad 62 is constructed for the site. The pad 62 is preferably sloped slightly to facilitate draining of water from the outlet port 150, which is preferably positioned at the lower end of the device 100. Such angling is particularly useful in embodiments in which vacuum pressures are not used. Furthermore, the sloped pad 62 can facilitate removing the permeable enclosure 110 with the material from an end 104 of the device 100.

Referring to FIG. 10, another embodiment for orienting the device 100 is illustrated. In this embodiment, the device 100 is sized for use on a dump trailer 64 or the like and is loaded on its platform. The internal permeable enclosure 110 can be approximately 35 feet long by 15 feet in circumference (i.e., about 7.5 feet wide when empty and laid flat), with the external impermeable enclosure 120 preferably about 10 to 15% larger. The end 104 of the external enclosure 120 can be re-sealable as with the embodiment of FIGS. 6A-6C above. The dump trailer 64 can take the device 100 to a landfill or other final destination, and can also be inclined to achieve the benefits as described with respect to FIG. 9 above.

Referring to FIG. 11, yet another embodiment for orienting the device 100 is illustrated. In this embodiment, the device 100 is sized to fit within a railcar 66. For example, the outer, impermeable enclosure of the device 100 can be approximately 52 feet long and 25 feet in circumference, and the permeable enclosure of the device 100 can be approximately 51 feet long and 24 feet in circumference. Filling and vacuum operations can be performed on the device 100 while contained in the railcar 66. Once filled, the device 100 can weigh up to approximately 114-tons depending on railcar capacity. If the consolidated material within the device 100 is to be dumped in a landfill, the railcar 66 can be a rotating dump train, and the entire device 100 can be disposed after one use. Alternatively, the device 100 can have a final vacuum drawn when it has reached the dump site. Then, the device 100 can be cut open at the perimeter of the railcar 66, and the top half of the device 100 can be lifted out of the railcar 66. Then, the material can be excavated, and the remaining half of the device 100 can be lifted out for disposal.

For the embodiments of FIGS. 10 and 11, the specific density of dewatered sediments or sludges can affect the sizing of the device 100. For example, dewatered sandy river sediment may have a density of about 104 pounds per cubic foot, while dewatered secondary wastewater treatment sludge having a high organic content may have a density of about 70 pounds per cubic foot. Therefore, a slightly smaller size of the device 100 may be required for the more dense sediments to avoid overloading the trailer 64 or railcar 66 or other support structure or transportation device. When the device 100 contains lower density sludge, however, multiple devices 100 can be stacked in the trailer 64 or railcar 66, for example, or a larger circumference device 100 can be used in the trailer 64 or railcar 66.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A device for removing liquid from a material, comprising:
a permeable enclosure for receiving the material through an inlet;
a impermeable enclosure enclosing the permeable enclosure;
a separation layer for maintaining a space between at least a portion of the permeable and impermeable enclosures; and
an outlet on the impermeable enclosure for drawing liquid from the material to outside the device, wherein the outlet is in communication with the space.

2. The device of claim 1, wherein the inlet is positioned at a substantially central location on the impermeable enclosure.

3. The device of claim 1, wherein the inlet comprises an end within the permeable enclosure for dividing flow of the material into the permeable enclosure.

4. The device of claim 1, further comprising a pump connectable to the inlet for filling the permeable enclosure with the material.

5. The device of claim 1, wherein the outlet is positioned proximate to a bottom of the device.

6. The device of claim 1, further comprising a vacuum pump connectable to the outlet, the vacuum pump for maintaining a vacuum in the space to assist in drawing liquid therefrom.

7. The device of claim 1, wherein the separation layer comprises a plurality of structures positioned between the permeable enclosure and the impermeable enclosure.

8. The device of claim 1, wherein the separation layer comprises pipes positioned along a length of the device.

9. The device of claim 1, wherein the separation layer comprises bumps or ridges attached to either the permeable or impermeable enclosures.

10. The device of claim 1, wherein the separation layer comprises a mesh conforming to a shape of the permeable and impermeable enclosures.

11. The device of claim 1, wherein at least a portion of the separation layer is attached to the impermeable enclosure.

12. The device of claim 1, wherein the impermeable enclosure is formed from at least one sheet of impermeable material having sealed edges.

13. The device of claim 1, wherein the impermeable enclosure comprises plastic.

14. The device of claim 1, wherein at least one end of the impermeable enclosure is resealable.

15. The device of claim 14, further comprising means for resealing the at least one of end of the impermeable enclosure.

16. The device of claim 1, wherein the permeable enclosure comprises a textile.

17. The device of claim 1, wherein the permeable enclosure comprising means for removing or inserting the permeable enclosure from or within the impermeable enclosure.

18. The device of claim 1, wherein the device is substantially tubular.

19. A device for removing liquid from a material, comprising:
a collapsible permeable enclosure for receiving the material through an inlet;
a collapsible impermeable enclosure sealed about the permeable enclosure;
means for maintaining a space between at least a portion of the permeable and impermeable enclosures; and
an outlet on the impermeable enclosure for drawing liquid from the material to outside the device, wherein the outlet is in communication with the space.

20. The device of claim 19, wherein the inlet is positioned at a substantially central location on the impermeable enclosure.

21. The device of claim 19, wherein the inlet comprises an end within the permeable enclosure for dividing flow of the material into the permeable enclosure.

22. The device of claim 19, further comprising a pump connectable to the inlet for filling the permeable enclosure with the material.

23. The device of claim 19, wherein the outlet is positioned proximate to a bottom of the device.

24. The device of claim 19, further comprising a vacuum pump connectable to the outlet, the vacuum pump for maintaining a vacuum in the space to assist in drawing liquid therefrom.

25. The device of claim 19, wherein at least a portion of the separation layer is attached to the impermeable enclosure.

26. The device of claim 19, wherein the impermeable enclosure is formed from at least one sheet of impermeable material having sealed edges.

27. The device of claim 19, wherein the impermeable enclosure comprises plastic.

28. The device of claim 19, wherein at least one end of the impermeable enclosure is resealable.

29. The device of claim 28, further comprising means for resealing the at least one of end of the impermeable enclosure.

30. The device of claim 19, wherein the permeable enclosure comprises a textile.

31. The device of claim 19, wherein the permeable enclosure comprising means for removing or inserting the permeable enclosure from or within the impermeable enclosure.

32. The device of claim 19, wherein the device is substantially tubular.

33. A system for removing liquid from material, comprising:
a permeable enclosure for receiving the material through an inlet;
an impermeable enclosure enclosing the permeable enclosure;
a separation layer for maintaining a space between at least a portion of the permeable and impermeable enclosures; and
a vacuum pump in communication with an outlet for forming a vacuum within the impermeable enclosure to draw liquid from the material, wherein the outlet is in communication with the space.

34. The system of claim 33, wherein the inlet is positioned at a substantially central location on the impermeable enclosure.

35. The system of claim 33, wherein the inlet comprises an end within the permeable enclosure for dividing flow of the material into the permeable enclosure.

36. The system of claim 33, further comprising a pump connectable to the inlet for filling the permeable enclosure with the material.

37. The system of claim 33, wherein the outlet is positioned proximate to a bottom of the device.

38. The system of claim 33, wherein the separation layer comprises a plurality of structures positioned between the permeable enclosure and the impermeable enclosure.

39. The system of claim 33, wherein the separation layer comprises pipes positioned along a length of the device.

40. The system of claim 33, wherein the separation layer comprises bumps or ridges attached to either the permeable or impermeable enclosures.

41. The system of claim 33, wherein the separation layer comprises a mesh conforming to a shape of the permeable and impermeable enclosures.

42. The system of claim 33, wherein at least a portion of the separation layer is attached to the impermeable enclosure.

43. The system of claim 33, wherein the impermeable enclosure is formed from at least one sheet of impermeable material having sealed edges.

44. The system of claim 33, wherein the impermeable enclosure comprises plastic.

45. The system of claim 33, wherein at least one end of the impermeable enclosure is resealable.

46. The system of claim 45, further comprising means for resealing the at least one of end of the impermeable enclosure.

47. The system of claim 33, wherein the permeable enclosure comprises a textile.

48. The system of claim 33, wherein the permeable enclosure comprising means for removing or inserting the permeable enclosure from or within the impermeable enclosure.

49. The system of claim 33, wherein the device is substantially tubular.

50. The system of claim 33, wherein the impermeable enclosure, the separation layer, and the permeable enclosure, are all deformable in response to the vacuum.

51. The system of claim 33, wherein the impermeable enclosure is collapsible on the separation layer in response to the vacuum.

52. A method of removing liquid from material, comprising not necessarily in sequence:
filling a permeable enclosure with the material through an inlet;
forming an impermeable enclosure about the permeable enclosure; and
drawing liquid from the material into an intentionally-maintained space between at least a portion of the permeable and impermeable enclosures and out of an outlet.

53. The method of claim 52, wherein the inlet is positioned at a substantially central location on the impermeable enclosure.

54. The method of claim 52, wherein filling the permeable enclosure with the material comprises separating a flow of the material within the permeable enclosure.

55. The method of claim 52, further the permeable enclosure is filled by a pump.

56. The method of claim 52, wherein the outlet is positioned proximate to a bottom of the device.

57. The method of claim 52, wherein the liquid is drawn from the material by drawing a vacuum at the outlet.

58. The method of claim 52, wherein the liquid is drawn from the material by gravity.

59. The method of claim 52, further comprising inclining the enclosures prior to drawing the liquid such that the outlet is at a substantially lowest point.

60. The method of claim 52, wherein the space is intentionally maintained between at least a portion of the permeable and impermeable enclosures by a separation layer.

61. The method of claim 60, wherein at least a portion of the separation layer is attached to the impermeable enclosure.

62. The method of claim 52, wherein the space is intentionally maintained between at least a portion of the permeable and impermeable enclosures by pipes positioned along a length of the device.

63. The method of claim 52, wherein the space is intentionally maintained between at least a portion of the permeable and impermeable enclosures by bumps or ridges attached to either the permeable or impermeable enclosures.

64. The method of claim 52, wherein the space is intentionally maintained between at least a portion of the permeable and impermeable enclosures by a mesh layer.

65. The method of claim 52, wherein the impermeable enclosure is formed from at least one sheet of impermeable material having sealed edges.

66. The method of claim 52, wherein the impermeable enclosure comprises plastic.

67. The method of claim 52, further comprising inserting the permeable enclosure within the impermeable enclosure prior to filling the permeable enclosure.

68. The method of claim 67, further comprising sealing at least one of end of the impermeable enclosure.

69. The method of claim 52, wherein the permeable enclosure comprises a textile.

70. The method of claim 52, wherein the permeable enclosure comprising means for removing or inserting the permeable enclosure from or within the impermeable enclosure.

71. The method of claim 52, wherein the permeable and impermeable enclosures are substantially tubular.

72. The method of claim 52, further comprising removing the permeable enclosure from the impermeable enclosure after drawing the liquid.

73. The method of claim 72, further comprising reinserting a new permeable enclosure within the impermeable enclosure after the removal.

74. The method of claim 73, further comprising resealing the impermeable enclosure after the reinsertion.

75. The method of claim 52, wherein the method is performed while the permeable and impermeable enclosures are mounted on a transportation device.
